(19) United States
(12) Patent Application Publication
(10) Pub. No.: US 2020/0382493 A1
(43) Pub. Date: Dec. 3, 2020

(54) PASSWORD SAFE

(71) Applicant: Joseph Gibbs, Windermere, FL (US)

(72) Inventor: Joseph Gibbs, Windermere, FL (US)

(21) Appl. No.: 16/532,223

(22) Filed: Aug. 5, 2019

Related U.S. Application Data
(60) Provisional application No. 62/854,194, filed on May 29, 2019.

(51) Int. Cl. H04L 29/06; G06F 3/0488; H04W 56/00

(52) U.S. Cl. CPC H04L 63/0861; H04L 63/04; H04W 56/002; G06F 3/0488

(57) ABSTRACT

An electronic device for safe storage of confidential information comprises a biometric sensor for validating whether a user is an authorized user, and is devoid of any wired or wireless communication capability and ports for possible unauthorized access to any of the confidential information, except access by and synchronization with a second like device whose authorized access has been obtained by the same user, and within a close proximity range.

### CROSS-REFERENCE TO RELATED APPLICATIONS

This application claims priority to U.S. Provisional Application No. 62/854,194 filed May 29, 2019, which is incorporated by reference herein.

### BACKGROUND OF THE INVENTION

The present invention relates to an electronic device for safe storage of passwords and other personal sensitive data, while making the data immune from hacking through wired and wireless communication links and other connections.

The usage of passwords to interface with today's electronic systems has become a multifaceted problem. The combination of the unique requirements that many systems require, combined with vulnerabilities that include spyware, malware, sabotage, blackmail, ransomware, and all forms of hacking have made the usage of passwords a complex task. There are many available solutions to store and manage passwords, however almost all have a “connected” element through a communication link, meaning that even in a highly encrypted form, the passwords are accessible from someone, somewhere online, by potentially hacking through some communication channel, wired or wireless.

A number of electronic password storage devices have been proposed, but none of these have provided the level of security needed in today's world with the ability and prevalence of hacking at an increase and concern to many users.

A number have communication capability. Even if there is an attempt to wall off or render the communication capability ineffective to potentially isolate the device, the possibility for hacking still exists.

A number have ports such as USB or SD card slots to enable some type of communication connection to the device. These ports and slots provide the possibility to hack into the device to obtain access to the information stored therein.

A number of the devices require only a master password to gain access to other passwords stored therein. However, if a hacker can get access to the master password or can bypass the master password hurdle, the whole purpose of the device is defeated.

There are many solutions for storing personal data, including passwords. Most, if not all, utilize existing solutions with an element that stores the login credentials in some form of an online backup.

Often these backups are stored on the user's commonly used storage systems (Google Drive, Dropbox, OneDrive, etc.). Commonly used cloud-based systems are easily security breached and commonly compromised.

Quick internet searches provide links to videos and instructions of how to hack those “encrypted” solution's backups once accessed. These internet provided links allow even amateur developers access to critical data.

### SUMMARY OF THE INVENTION

The invention provides a device/system that:
1) Provides a fully internet disconnected and isolated primary device to store extremely personal and private confidential data (OnlyMyData) that is only accessible by the owner of the device, by biometric data such as fingerprint reading and/or facial recognition,
2) Provide a secondary device or other safe alternative to mirror the (OnlyMyData) in case the primary device is lost or damaged, and
3) Ensure that all devices provide the best protection against hacking and including self-destruction of on-board data if physically breached or tampered with, or if multiple unauthorized and failed access attempts occur.

The invention provides a handheld device that has no online, or cloud storage for possible public access. It is in a sealed self-contained environment. The device has biometric sensors, such as fingerprint sensors and/or a camera for facial recognition, plus the inputting of a user id code as the required means to obtain access to the information stored in the device.

The device has self-contained software that stores login information including usernames, passwords, and other personal valuable confidential data that should be safeguarded such as computer server network information, website user IDs and passwords, ATM and credit card passwords, bank account numbers and passwords.

The device is only accessible by the “owner user”, due to the biometric sensing. All data is stored locally without possible access by any wired or wireless communication.

If the device is physically compromised or senses a physical intrusion or tampering (broken open, sawed into, etc.), or if unauthorized access is attempted and failed, the data is stored in such as way as it is destructed and non-recoverable so that the confidentiality of the data is maintained.

The device may be charged by surface induction and doesn't have any accessible communication ports, such as USB, SD card slot, wifi connection, or Bluetooth. It is a truly disconnected device. If any common charge port is utilized in the design, it will be for power only and have no data access capability and utilized for power/recharging only.

The only backup for the data in the primary device can be a duplicate secondary device which can be synchronized in the same cradle or platform as the primary device, or if in close proximity to the primary device outside of the cradle. Both devices must be manually synchronized using the owner user's biometric and facial authentication before data can be exchanged between the two devices, and even then, communication is only possible if both devices are on the cradle, or if not on the cradle, through a wireless connection with a limited close proximity range on the order of a foot or so, and even then in encrypted form.

### BRIEF DESCRIPTION OF THE DRAWINGS

FIG. 1 shows a front view of a password safe according to an embodiment of the invention;

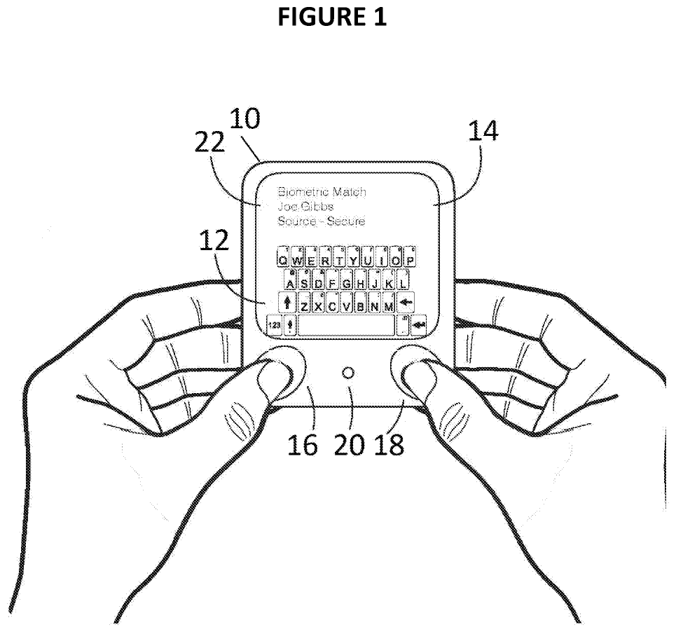

FIG. 2 shows a rear view of the password safe of FIG. 1;

FIG. 2A is a side view of the password safe;

FIG. 3 shows a front view of a charging platform for charging the password safe;

FIG. 4 is a perspective view of the charging platform of FIG. 3; and

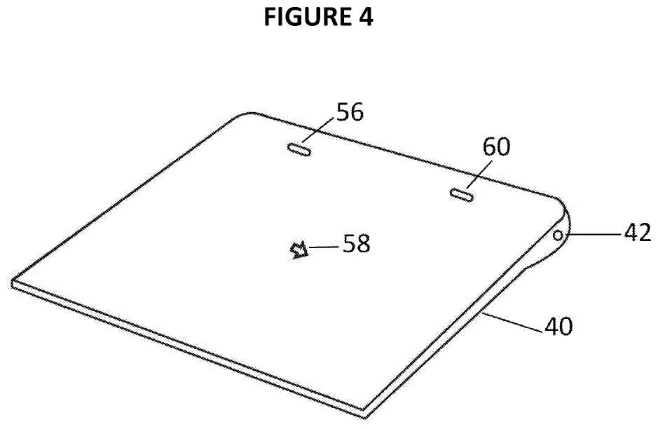

FIG. 5 is a front view of two password safes on a charging platform or cradle.

### DESCRIPTION OF A PREFERRED EMBODIMENT

A preferred embodiment of a password safe according to the invention will now be described as an example, but the invention is not limited to this preferred embodiment or any particular details of this embodiment.

The invention provides a portable, self-contained electronic storage device for storing confidential information, comprising: a housing; a processor in the housing; a biometric sensor on the housing connected to the processor for detecting at least one biometric attribute of a user; an input device on the housing connected to the processor for enabling a user to input confidential information of the user; a storage medium in the housing connected to the processor, for storing confidential information of the user; a display on the housing for display of confidential information; and a program operative to run on the processor for checking whether the biometric attribute of the user as sensed by the biometric sensor validates the identity of the user as an authorized user permitting access to the confidential information, wherein the device is devoid of communication capability over wired and wireless computers and networks to prevent possible access to the device through such computers and networks, and wherein the device is devoid of any wired ports enabling possible access through any wired connections and card slots, except access by and synchronization with a second like device whose authorized access has been obtained by the same user, and within a close proximity range.

The biometric sensor may comprise a fingerprint sensor, and may comprise two fingerprint sensors. The biometric sensor may comprise a facial recognition sensor. The biometric sensor may comprise a fingerprint sensor and facial recognition sensor, and wherein the program is operative to permit access only if fingerprint access is validated, and facial recognition is validated to be the authorized user. The device may further comprise a cradle for charging the device wirelessly by induction when the device is in close proximity to the cradle. The cradle may have two device interface regions for interfacing with first and second devices when each device has recognized the user as an authorized user, and wherein the program is operative to exchange confidential information stored in the first device with the second device within a close proximity range. The program may be operative to erase all confidential information after a predetermined number of attempts to access the confidential information by a user whose biometric attributes do not identify the user as an authorized user. The program may be operative to erase all confidential information if the device senses a physical tampering. The program may be operative to communicate alert signals to the user if any of the confidential information has reached the end of an expiration period and needs to be replaced. The confidential information may include a QR code.

The invention provides a self-contained electronic storage device, comprising: a memory for storing confidential information of a user; and a biometric sensor for receiving personal biometric data unique to the user, and for providing that access to the device and confidential information stored in the memory is limited to the user having personal biometric data, wherein the device is devoid of any wired or wireless communication capability and parts for possible access to any of the confidential information. The biometric sensor may comprise at least one of a fingerprint sensor, a facial recognition sensor, and retinal scan sensor.

As shown in the attached Figures, a password safe 10 is about half the size of a conventional smartphone, measuring 2.44″ wide, 2.7″ high and 0.20″ deep. The password safe 10 comprises a housing which has a touch screen keyboard 12 on a backlit color display 14, two biometric fingerprint sensors left and right 16, 18 and a camera 20. The display 14 can display status messages 22 such as the presence of a biometric match, the name of the user and whether the source (user) is secure.

The device can be easily carried by the user. There may be mounts that allow the device to physically piggyback or attach to a phone or other commonly carried primary device, but without any electronic connection.

The two biometric fingerprints 16, 18 can be arranged to unlock the camera 20 for facial recognition that is located on the same side of the device as the fingerprint sensors 16, 18, in a way that first requires fingerprint matches, and then facial recognition for the device to be fully accessed. The facial recognition may comprise a retinal scan. In some cases only one of fingerprint recognition or facial recognition will be sufficient. After successful biometric verification by both fingerprint and/or facial recognition, the program may also require keying in a master password as the last step in the authentication process.

The password safe device is designed such that the fingerprint sensors 16, 18 and camera 20 are minimal in size in reference to other actual device sizes, allowing the majority of the user facing surface real estate to be used for a digital interface. The keyboard 12 is all digital with soft keys and part of the touch display screen 14.

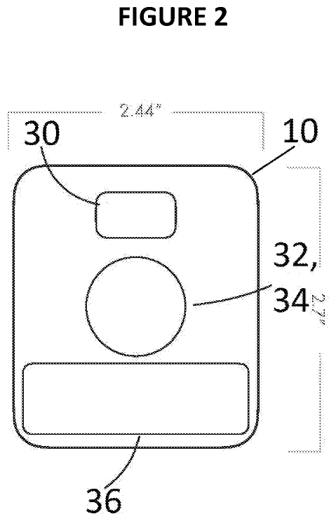

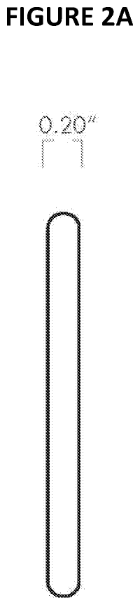

As shown in FIG. 2, the password safe has a processor with a self-destructible memory 30, an induction charger 32 and near field radio transmitter/receiver 34 and a rechargeable battery pack 36.

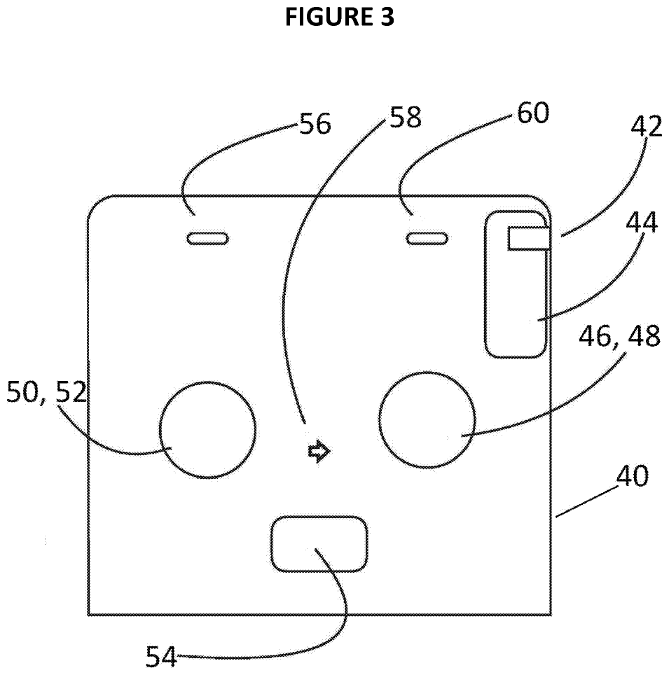

FIG. 3 shows a charging platform 40 having a DC power connector port 42, charging and control circuiting 44, a first (right) induction charger 46 and near field radio transmitter/receiver 48, a second (left) induction charger 50 and a new field radio transmitter/receiver 52, an encryption circuit 54, a left charging indicator 56, a synch indicator 58, and a right charging indicator 60. Two password safe devices 10, 10A can be placed side by side near the left and right induction chargers 50 and 46, as shown in FIG. 3. When both devices are accessed and the secondary device is being synched with the primary device, the synch indicator 58 lights up to advise the user that synchronization is occurring.

The processor in the password safe has program control software to control operations of the password safe 10. The software will have common user requirements including individual master password management to store fingerprints and facial recognition of the authorized user. The software will have auto-lock setting with multiple and custom lengths of time to terminate authorized access if the user is not actively using the device for input or retrieval of data for a certain time period, for example, 30 minutes.

A user self-destruct feature in the software will be able to be set for self-destruction of the stored password data or disabling of the device after a custom number of failed login attempts by the user.

The device has a historical user login or attempt summary, which can be reset.

The software of the device has the ability for the user to create folders allowing the user to group similar passwords and login credentials. Example: User has five personal emails and creates a folder called Personal Emails.

The device has a catalog of templates of commonly used login/password/credentials. WIFI login, emails, website info, server credentials, etc.

The device has a customizable template builder for advanced users where a user may design their own template. For example, an IT person in a certain government situation has a common set of data required to access a system that most people would never require. The template builder allows full form design and field control.

The device could provide password suggestions, so that upon request from the user, a highly complicated password generator is provided in the proper format of length and proper acceptable character requirements, such as a combination of letters, numbers, capital letters, special characters or the like, which meets a certain minimal level of security. For security reasons, some passwords automatically expire after a certain time period and become invalid. For passwords that need to be changed periodically before they expire, say every two months, the program can remind the user in advance prior to the time the password will expire so that a new password can be created before the time expires. The software also has the ability to generate a two-dimensional QR code, in response to keyed input of the required info to generate such a QR code. The camera 20 may capture an image of a QR code from an outside source.

The software will provide an option to master purge all the data which will self-destruct all current data.

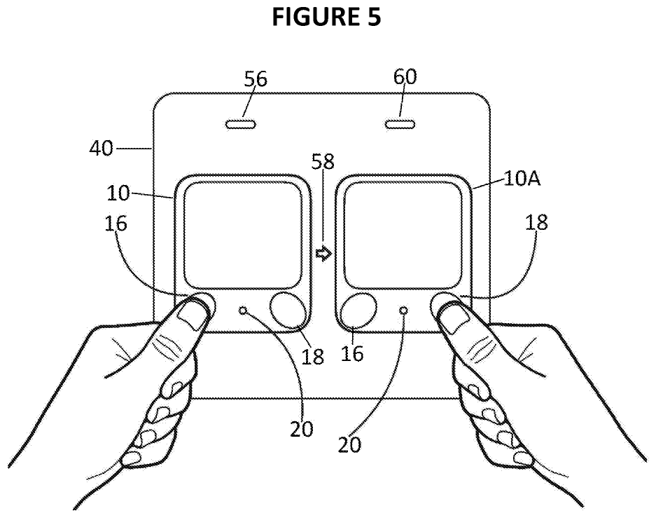

The user will have the ability to have the primary device communicate with one or more secondary devices to mirror the current configuration of the primary device primarily for backup and safeguarding, as shown in FIG. 5.

Synchronization will require both devices be fully unlocked and accessed via the user interface, and manually placed, into mirror mode and placed in the physical charging platform or cradle for actual physical connectivity. Successful pairing allows synchronization to occur. Failure to follow the strict safeguarded procedure will result in a non-connection. Alternatively, synchronization can occur outside the cradle if the devices are very close to each other.

The primary device 10 contains a user setting that can modify the factory set details for this functionality. For example, if the pairing/sync is attempted six times unsuccessfully with in ten minutes, both devices self-destruct their memory contents.

The secondary device 10A also contains all of the same menu options as the primary device 10. In case the primary device 10 is lost, damaged or compromised, the secondary device 10A mirrors the primary device 10. If that occurs, the secondary device 10A becomes the primary device 10 and a new secondary device 10A can be programmed to copy all of the data from the primary device 10 to mirror it. A new replacement device 10A could be configured to mirror the new primary device.

Although a preferred embodiment has been described, a device made according to the invention does not need to have all of the features described herein. The scope of the invention is not limited to this embodiment and is defined only by way of the appended claims.

1. A portable, self-contained electronic storage device for storing confidential information, comprising:
a housing;
a processor in the housing;
a biometric sensor on the housing connected to the processor for detecting at least one biometric attribute of a user;
an input device on the housing connected to the processor for enabling a user to input confidential information of the user;
a storage medium in the housing connected to the processor, for storing confidential information of the user;
a display on the housing for display of confidential information; and
a program operative to run on the processor for checking whether the biometric attribute of the user as sensed by the biometric sensor validates the identity of the user as an authorized user permitting access to the confidential information, and operative to enable wireless access by and synchronization with a second like device only if authorized access has been obtained by the same user, and within a close proximity range, wherein the device is otherwise devoid of communication capability over wired and wireless computers and networks to prevent possible access to the device through such computers and networks, and wherein the device is devoid of any wired ports enabling possible access through any wired connections and card slots, except wireless access by and synchronization with a second like device whose authorized access has been obtained by the same user, and within a close proximity range.

2. The device according to claim 1, wherein the biometric sensor comprises a fingerprint sensor.

3. The device accordingly to claim 2, wherein the biometric sensor comprises two fingerprint sensors.

4. The device according to claim 1, wherein the biometric sensor comprises a facial recognition sensor.

5. The device according to claim 1, wherein the biometric sensor is a fingerprint sensor and facial recognition sensor, and wherein the program is operative to permit access only if fingerprint access is validated, and facial recognition is validated to be the authorized user.

6. The device according to claim 1, further comprising a cradle for charging the device wirelessly by induction when the device is in close proximity to the cradle.

7. The device according to claim 6, wherein the cradle has two device interface regions for interfacing with first and second devices when each device has recognized the user as an authorized user, and wherein the program is operative to exchange confidential information stored in the first device with the second device within a close proximity range.

8. The device according to claim 1, wherein the program is operative to erase all confidential information after a predetermined number of attempts to access the confidential information by a user whose biometric attributes do not identify the user as an authorized user.

9. The device according to claim 1, wherein the program is operative to erase all confidential information if the device senses a physical tampering.

10. The device accordingly to claim 1, wherein the program is operative to communicate alert signals to the user if any of the confidential information has reached the end of an expiration period and needs to be replaced.

11. The device according to claim 1, wherein the confidential information includes a QR code.

12. A self-contained electronic storage device, comprising:
a memory for storing confidential information of a user; and
a biometric sensor for receiving personal biometric data unique to the user, and
a program operative for providing that access to the device and confidential information stored in the memory is limited to the user having personal biometric data, and operative to enable wireless access by and synchronization with a second like device only if authorized access has been obtained by the same user, and within a close proximity range, wherein the device is otherwise devoid of any wired or wireless communication capability and parts for possible access to any of the confidential information.

13. The device according to claim 12, wherein the biometric sensor comprises at least one of a fingerprint sensor, a facial recognition sensor, and retinal scan sensor.
